(19) United States
(12) Patent Application Publication
(10) Pub. No.: US 2004/0151813 A1
(43) Pub. Date: Aug. 5, 2004

(54) Citrus paper application sheet for applying to freshly exposed or cut surfaces of fruit to prevent browning

(76) Inventor: Kathleen A. Lappe, Bowling Green, KY (US)

Correspondence Address: KATHLEEN ABIGAIL LAPPE, 329 REDBIRD TRAIL, BOWLING GREEN, KY, 42101, US

(21) Appl. No.: 10/356,212

(22) Filed: Jan. 31, 2003

(51) Int. Cl. A23C 3/00

(52) U.S. Cl. 426/323

(57) ABSTRACT

A Citrus Paper Application Sheet for applying to exposed or cut surfaces of fruit to prevent browning. The sheet is designed to adhere to the fruit once dampened. The sheet is further designed to enable it to be measured and cut to particular lengths and widths, so that it duplicates the precise functioning of whatever particular length and width is preferred for application.

### DETAILED DESCRIPTION

The paper application is comprised of a citric juice concentrate or ascorbic acid (vitamin C), purified water, and coated paper. The coated paper is immersed in the citric juice concentrate, water, or ascorbic acid, water, then dried and cut into the citrus paper application sheets. The applying effected by the instant invention is particularly designed to prevent browning of the freshly exposed or cut surface of fruit over which it is applied.

It is desirable for an exposed or cut section of fruit to not brown. Accordingly, a sheet of citric based, or ascorbic acid based, coated paper, dampened then applied to the fruit, is capable of providing a barrier that prevents browning.

The preferred method of application is for the sheet to be dampened under running water then applied directly to freshly exposed or cut part of fruit.

For best results; after application, keep all fruit, except bananas, in refrigerator.

The use of 100% citric juice concentrate and, water or 100% ascorbic acid (vitamin C) and, water, for this invention is responsible on its own, for providing a non-browning agent where as, the basic coated paper for this invention adheres as it dries creating a barrier preventing less then 3% oxygen. Thus, allowing the citric juice concentrate or ascorbic acid to prevent browning long term.

1. A method of preventing browning of exposed fruit by applying the Citrus Paper Application Sheet with water directly to the freshly exposed or cut fruit, said, citrus paper application sheet comprising:
a sheet of 20-80lb, smooth, coated paper (commonly found, at any retail store carrying paper products) in lengths of 1″ to 500″, in widths of 1″ to 500″, in a solid white brilliance of 84-96; and
100% citric juice concentrate and (purified) water (commonly found, at any grocery store in the freezer section or shelf) with proportions of 400 GPL (grams per liter), a ratio range of eight parts 100% citric juice concentrate to one part purified water.

2. A method of preventing browning of exposed fruit by applying the Citrus Paper Application Sheet with water directly to the freshly exposed or cut fruit, said, citrus paper sheet comprising:
a sheet of 20-80 lb, smooth, coated paper (commonly found, at any retail store carrying laser, jet or copy paper) in lengths of 1″ to 500″, in widths of 1″ to 500″, in a solid white brilliance of 84-96; and
100% ascorbic acid (vitamin C), and (purified) water with a ratio range of ten parts 100% ascorbic acid (vitamin C) to one part purified water.

3. A method according to claim 1 and 2 wherein the ratio range of the 100% citrus juice concentrate or the ascorbic acid to water, can be slightly modified for exactly the same or similar results desired for preventing browning.

4. A method according to claim 1 and 2 wherein the coated paper sheet in lengths of 1″ to 500″, in widths of 1″ to 500″ and can be measured and cut into shorter, customized-lengths and widths.

5. A method according to claim 4 whereas the most preferred lengths and widths are ranged in lengths of 1″ to 12″, and in widths of 1″ to 12″.

6. A method according to claim 4 wherein the coated paper comes in a variety of different standard colors.

7. A method according to claim 1 whereas the basic 100% citric juice concentrate is comprised from these five citrus groups; Orange, Lemon, Lime, Grapefruit, and Mandarin/Tangerine.

8. The method according to claim 1 wherein the preventing browning agent is comprised of 100% citric juice concentrate, and water, proportions being: 400 GPL (grams per liter), a ratio of seven parts 100% citric juice concentrate to one part water.

9. The method according to claim 2 wherein the preventing browning agent is comprised of 100% ascorbic acid (vitamin C), and water with a proportion ratio range of one part 100% ascorbic acid and up to ten parts water.

10. A method according to claim 1 and 2 whereas the basic coated paper structure is comprised of four layers;
a Receiver-made from micro-particles, gelatin, or polymer, a Barrier-made from polytheyne, cast coating, or wash coating, a Base-made from cellulose or film, and a Backing-made from various plastics.

11. A method according to claim 10 whereas the basic coated paper can be defined as; band paper, fine paper, ink jet paper, laser paper, copy paper, or cover paper.

12. A method according to claim 1 and 2 whereas the coated paper can be defined as; band paper, fine paper, or cover paper.

13. A method according to claim 10 whereas a paper structure without the backing is sufficient.

14. A method according to claim 11 whereas added to the basic coated paper structure as a non-browning agent is 100% citric juice concentrate, and water, proportions 400 GPL (grams per liter) a ratio of approximately seven parts 100% citric juice concentrate to one part water.

15. A method according to claim 11 whereas added to the basic coated paper structure as a non-browning agent is 100% ascorbic acid (vitamin C), and water, proportion ratio range of one part ascorbic acid and up to ten parts water.

16. The method according to claim 14 whereas the 100% citric juice concentrate, and water, proportions 400 GPL (grams per liter) a ratio of seven parts 100% citric juice concentrate to one part water, comprises the preservative agents; sodium bisulfite, and sodium benzoate, proportions regulated by the FDA (Food and Drug Administrative) based on pounds per 1000 gallon batch.

17. A method according to claim 16 whereas the citric preventing browning agent of 100% citric juice concentrate, and water, is sufficient without the preservative agents; sodium bisulfite, and sodium benzoate.
